(19) United States
(12) Patent Application Publication
(10) Pub. No.: US 2017/0043835 A1
(43) Pub. Date: Feb. 16, 2017

(54) METHOD AND SYSTEM FOR CONTROLLING A LAMP IN A BICYCLED DEVICE

(71) Applicants: Le Holdings(Beijing)Co., Ltd., Beijing (CN); LETV SPORTS CULTURE DEVELOP(BEIJING) CO., LTD., Beijing (CN)

(72) Inventor: Dalong Li, Beijing (CN)

(21) Appl. No.: 15/222,888

(22) Filed: Jul. 28, 2016

Related U.S. Application Data
(63) Continuation of application No. PCT/CN2016/082057, filed on May 13, 2016.

(30) Foreign Application Priority Data
Aug. 11, 2015 (CN) 201510491135.7

(51) Int. Cl. B62J 6/04; H05B 37/02; B60Q 1/44

(52) U.S. Cl. CPC B62J 6/04; B60Q 1/445; H05B 37/0227; H05B 37/0281

(57) ABSTRACT

Disclosed are a method and a system for controlling a lamp in a bicycled device. The method includes: detecting an acceleration value of the bicycled device; and controlling a brake lamp of the bicycled device to be switched on and off, according to the acceleration value of the bicycled device. With the technical solution according to the embodiment of the invention, the brake lamp of the bicycled device can be controlled automatically by detecting the acceleration value of the bicycled device to thereby improve the safety of the bicycling bicycler, better satisfy the user, and improve the experience of the user.

### CROSS REFERENCE TO RELATED APPLICATIONS

This application is a continuation of International Application No. PCT/CN2016/082057, filed on May 13, 2016, which is based upon and claims priority to Chinese Patent Application No. 201510491135.7, filed with the Chinese Patent Office on Aug. 11, 2015 and entitled “method and system for controlling a lamp in a bicycled device”, which is hereby incorporated by reference in its entirety.

### TECHNICAL FIELD

The present invention relates to the field of manufacturing a bicycled device, and particularly to a method and system for controlling a lamp in a bicycled device.

### BACKGROUND

At present, bicycling has been increasingly popular to people as low-carbon, environment-conserving, and healthy sporting and traveling means. Many riders prefer to listen to music or radio, or entertain themselves otherwise while riding to thereby make their riding more joyful.

The majority of the existing bicycles have no lamps installed therein so that when a rider riding his or her bicycle is braking, then another rider immediately following the bicycle may neither know the state of the bicycle in a timely manner nor see clearly a front road at dark, so that an accident may tend to occur, thus resulting in a hidden safety risk.

In view of this, it is highly desirable in the industry to address the issue of how to improve the safety of the riding rider.

### SUMMARY

Embodiments of the invention provide a method and system for controlling a lamp in a bicycled device so as to address the problem in the prior art of a hidden safety risk to a riding rider, thus satisfying the user and improving the experience of the user.

A method for controlling a lamp in a bicycled device according to an embodiment of the invention includes:
detecting an acceleration value of the bicycled device; and
controlling a brake lamp of the bicycled device to be switched on and off, according to the acceleration value of the bicycled device.

Particularly controlling the brake lamp of the bicycled device to be switched on and off, according to the acceleration value of the bicycled device includes:
determining a motion state of the bicycled device according to the acceleration value;
switching on the brake lamp, when the motion state of the bicycled device is decelerating, and the brake lamp is switched off;
setting a hold-on period of time; and
switching off the brake lamp after the preset hold-on period of time elapses.

Particularly controlling the brake lamp of the bicycled device to be switched on and off, according to the acceleration value of the bicycled device includes:
determining a motion state of the bicycled device according to the acceleration value;
switching on the brake lamp, when the motion state of the bicycled device is decelerating, and the brake lamp is switched off; and
switching off the brake lamp, when the motion state of the bicycled device is decelerating, and the brake lamp is switched on.

Particularly determining the motion state of the bicycled device according to the acceleration value includes:
when the acceleration value is below a preset acceleration threshold, determining the motion state of the bicycled device as decelerating; and
when the acceleration value is not below the preset acceleration threshold, determining the motion state of the bicycled device as non-decelerating.

A system for controlling a lamp in a bicycled device according to an embodiment of the invention includes a brake lamp device, an acceleration detecting device, and a controller, wherein:
the acceleration detecting device is configured to detect an acceleration value of the bicycled device, and to transmit the acceleration value to the controller; and
the controller is configured to receive the acceleration value transmitted by the acceleration detecting device, and to control a brake lamp of the bicycled device to be switched on and off, according to the acceleration value.

Particularly the system further includes:
a timer configured to receive a timing start instruction transmitted by the controller, and to feed a timing end message back to the controller after a preset hold-on period of time elapses; and
the controller is configured:
   to determine a motion state of the bicycled device according to the acceleration value; and
   to switch on the brake lamp device, when the motion state of the bicycled device is decelerating, and the brake lamp device is switched off; to transmit the timing start instruction to the timer; and to switch off the brake lamp device upon reception of the timing end message fed back by the timer.

Particularly the controller is configured:
to determine a motion state of the bicycled device according to the acceleration value;
to switch on the brake lamp, when the motion state of the bicycled device is decelerating, and the brake lamp is switched off; and
to switch off the brake lamp, when the motion state of the bicycled device is non-decelerating, and the brake lamp is switched on.

Particularly the controller is configured:
to determine the motion state of the bicycled device as decelerating when the acceleration value is below a preset acceleration threshold; and
to determine the motion state of the bicycled device as non-decelerating when the acceleration value is not below the preset acceleration threshold.

Particularly, the bicycled device includes one of a bicycle, an electro-mobile, and a motorcycle.

With the method and system for controlling a lamp in a bicycled device according to the embodiments of the invention, the acceleration value of the bicycled device is detected, and the brake lamp of the bicycled device is controlled to be switched on and off, so that the brake lamp of the bicycled device can be controlled automatically by detecting the acceleration value of the bicycled device, to thereby improve the safety of the bicycling bicycler, better satisfy the user, and improve the experience of the user.

### BRIEF DESCRIPTION OF THE DRAWINGS

In order to make the technical solutions according to the embodiments of the invention or in the prior art more apparent, the drawings to which a description of the embodiments or the prior art refers will be briefly introduced below, and apparently the drawings to be described below are merely illustrative of some of the embodiments of the invention, and those ordinarily skilled in the art can derive from these drawings other drawings without any inventive effort. In the drawings:

FIG. 1 is a flow chart of a method for controlling a lamp in a bicycled device according to an embodiment of the invention;

FIG. 2 is a flow chart of controlling a brake lamp of a bicycled device to be switched on and off, according to a detected acceleration value according to an embodiment of the invention;

FIG. 3 is another flow chart of controlling a brake lamp of a bicycled device to be switched on and off, according to a detected acceleration value according to an embodiment of the invention;

FIG. 4A is a schematic structural diagram of a system for controlling a lamp in a bicycled device according to an embodiment of the invention;

FIG. 4B is a schematic structural diagram of another system for controlling a lamp in a bicycled device according to an embodiment of the invention; and

FIG. 4C is a schematic structural diagram of a further system for controlling a lamp in a bicycled device according to an embodiment of the invention.

### DETAILED DESCRIPTION

In order to make the objects, technical solutions, and advantages of the embodiments of the invention more apparent, the technical solutions according to the embodiments of the invention will be described below clearly and fully with reference to the drawings in the embodiments of the invention, and apparently the embodiments described below are only a part but not all of the embodiments of the invention. Based upon the embodiments here of the invention, all the other embodiments which can occur to those skilled in the art without any inventive effort shall fall into the scope of the invention.

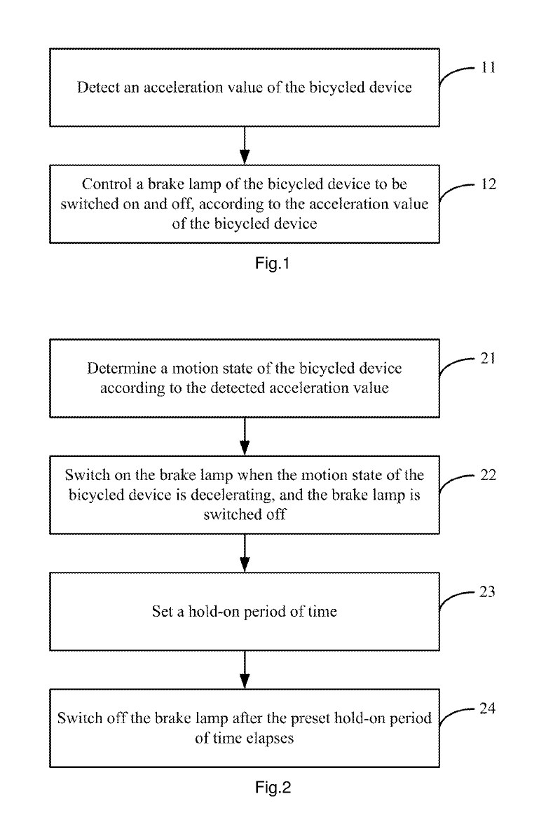

Referring to FIG. 1, an embodiment of the invention provides a method for controlling a lamp in a bicycled device, a particular flow of which is as follows:

The step 11 is to detect an acceleration value of the bicycled device.

The “bicycled device” as referred to in the embodiment of the invention can refer to a bicycle, an electro-mobile, or a motorcycle.

In an embodiment of the invention, the acceleration value of the bicycled device can be detected by an acceleration sensor. Particularly the acceleration value of the bicycled device can be detected in real time, or the acceleration value of the bicycled device can be detected at a preset interval of time.

The step 12 is to control a brake lamp of the bicycled device to be switched on and off, according to the acceleration value of the bicycled device.

Here the “brake lamp” of the bicycled device in the embodiment of the invention is generally installed at the tail of the bicycled device, and the general color thereof is red, so that an immediately following vehicle can notice that the front vehicle is being braked, thus preventing a rear-end collision accident from occurring, where the immediately following vehicle can be a bicycled device according to an embodiment of the invention, or can be another device than a bicycled device, e.g., an automobile, etc., and the front vehicle is a bicycled device according to an embodiment of the invention.

In an embodiment of the invention, the brake lamp of the bicycled device can be controlled to be switched on and off in the step 12 in the following two implementations dependent upon a real condition without any limitation thereto:

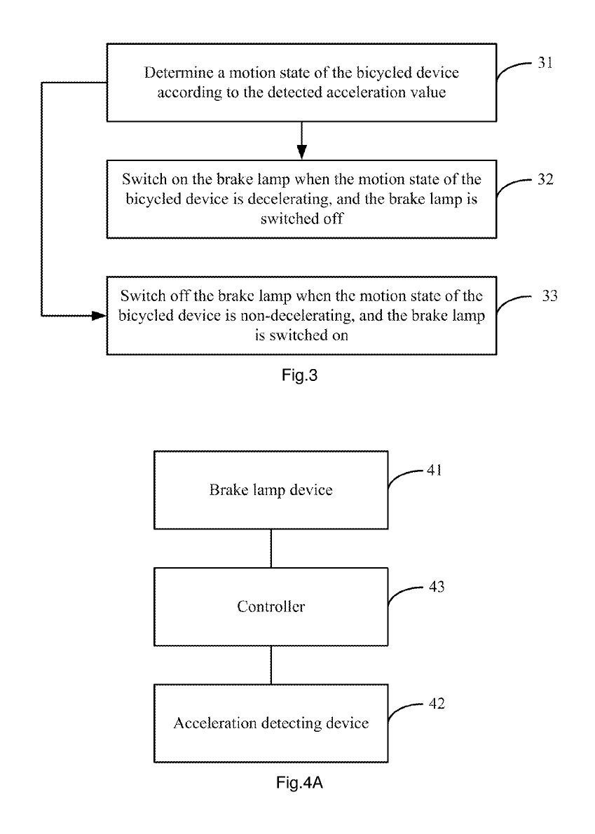

In a first implementation as illustrated in FIG. 2, the step 12 can be performed particularly in the following steps:

The step 21 is to determine a motion state of the bicycled device according to the detected acceleration value;

The step 22 is to switch on the brake lamp, when the motion state of the bicycled device is decelerating, and the brake lamp is switched off;

The step 23 is to set a hold-on period of time;

Here the step 22 and the step 23 can be performed concurrently, that is, the hold-on period of time can be set while switching on the brake lamp; or firstly the step 22 and then the step 23 can be performed, that is, the hold-on period of time can be set after the brake lamp is switched on.

The step 24 is to switch off the brake lamp after the preset hold-on period of time elapses.

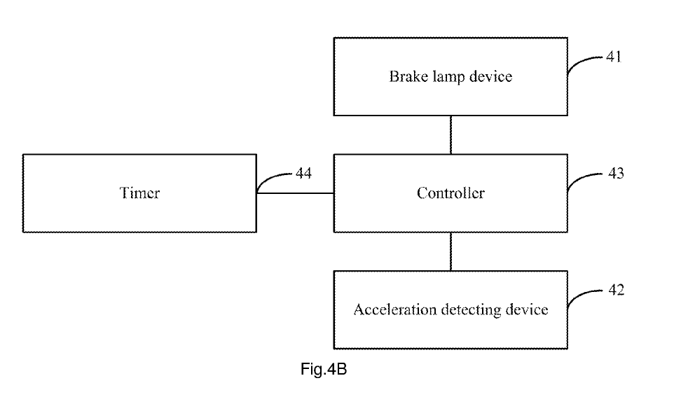

In a first implementation as illustrated in FIG. 3, the step 12 can be performed particularly in the following steps:
The step 31 is to determine a motion state of the bicycled device according to the detected acceleration value;
The step 32 is to switch on the brake lamp, when the motion state of the bicycled device is decelerating, and the brake lamp is switched off; and
The step 33 is to switch off the brake lamp, when the motion state of the bicycled device is non-decelerating, and the brake lamp is switched on.

In either the first approach or the second approach above, the motion state of the bicycled device is determined according to the detected acceleration value, which can be performed in the following flow but without any limitation thereto:
An acceleration value threshold is preset, and when the detected acceleration value is below the acceleration value threshold, the motion state of the bicycled device will be determined as decelerating; and when the detected acceleration value is not below the acceleration value threshold, the motion state of the bicycled device will be determined as non-decelerating.

Optionally the acceleration threshold can be zero, so that when the detected acceleration value is below zero, that is, the acceleration value is negative, then it indicates that the bicycled device is decelerating, and when the detected acceleration value is zero or more, that is, the acceleration value is positive, then it indicates that the bicycled device is accelerating (more than zero) or traveling at a constant speed (zero) or stationary (zero), that is, the bicycled device is non-decelerating.

With the technical solution according to the embodiment of the invention, the acceleration value of the bicycled device is detected, and the brake lamp of the bicycled device is controlled to be switched on and off, so that the brake lamp of the bicycled device can be controlled automatically by detecting the acceleration value of the bicycled device to thereby improve the safety of the bicycling bicycler, better satisfy the user, and improve the experience of the user.

Based upon the same inventive idea, an embodiment of the invention further provides a system for controlling a lamp in a bicycled device, and since the system addresses the problem under a similar principle to the method for controlling a lamp in a bicycled device, reference can be made to the implementation of the method for an implementation of the system, so a repeated description thereof will be omitted here.

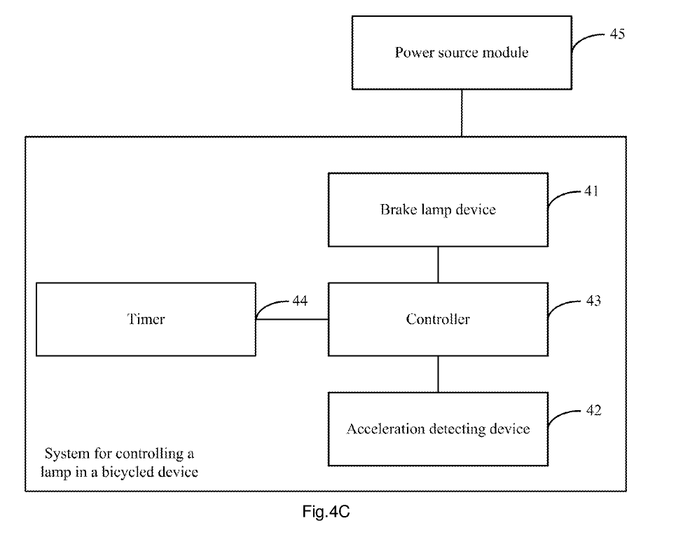

Referring to FIG. 4A, an embodiment of the invention provides a system for controlling a lamp in a bicycled device, which includes a brake lamp device 41, an acceleration detecting device 42, and a controller 43, where:
The acceleration detecting device 42 is configured to detect an acceleration value of the bicycled device, and to transmit the acceleration value to the controller 43; and
The controller 43 is configured to receive the acceleration value transmitted by the acceleration detecting device 42, and to control a brake lamp of the bicycled device to be switched on and off, according to the acceleration value of the bicycled device.

Optionally the controller 43 can be configured:
To determine a motion state of the bicycled device according to the detected acceleration value;
To switch on the brake lamp, when the motion state of the bicycled device is decelerating, and the brake lamp is switched off; and
To switch off the brake lamp, when the motion state of the bicycled device is non-decelerating and the brake lamp is switched on.

Optionally the controller 43 configured to determine the motion state of the bicycled device according to the detected acceleration value can be configured:
To determine the motion state of the bicycled device as decelerating when the acceleration value is below a preset acceleration threshold; and
To determine the motion state of the bicycled device as non-decelerating when the acceleration value is not below the preset acceleration threshold.

Optionally the brake lamp device 41 in an embodiment of the invention is installed at the tail of the bicycled device, and the general color thereof is red, so that an immediately following vehicle can notice that the front vehicle is being braked, thus preventing a rear-end collision accident from occurring, and particularly the brake lamp device 41 can include but will not be limited to a Light Emitting Diode (LED) lamp.

Optionally the acceleration detecting device 42 in an embodiment of the invention can include but will not be limited to an acceleration sensor, and in a particular implementation, the acceleration sensor can be a three-axis acceleration sensor primarily characterized in there axial X, Y, and Z sensors built therein, where the X axis refers to one of the two-dimension coordinate axes in the forward and backward direction, and the Y axis refer to the other one of the two-dimension coordinate axes in the leftward and rightward direction, and the Z axis refers to the direction perpendicular to the ground, in which there is an acting gravity acceleration normally unlike the X and Y axes. The respective coordinate axes are acceleration detection axes respectively, and corresponding acceleration values can be generated on the three acceleration detection axes X, Y, and Z as a function of the motion direction, and a varying speed of motion while the bicycled device is traveling.

In an embodiment of the invention, a negative acceleration value on the X axis being detected indicates that the vehicle is traveling forward while decelerating, that is, the vehicle will be traveling linearly while being braked, and at this time, the distance between the vehicle and an immediately following vehicle will be decreasing; and in this case, it may be very likely for the vehicles to collide, where this collision likelihood will be higher when the negative acceleration value is larger. At this time, the brake lamp is set to be switched on. An acceleration value in the positive direction of the X axis being detected indicates that the vehicle is traveling linearly while accelerating, that is, the vehicle is traveling forward while accelerating, so that the vehicle is traveling away from the immediately following vehicle at an increasing speed; and in this case, the vehicles generally will not collide, and at this time, the brake lamp is set to be switched off.

Optionally the controller 43 can include but will not be limited to one of a monolithic processor, a Field-Programmable Gate Array (FPGA), and a Digital Signal Processor (DSP).

In summary, in the embodiment of the invention, the acceleration value of the bicycled device is detected, and the brake lamp of the bicycled device is controlled to be switched on and off, so that the brake lamp of the bicycled device can be controlled automatically by detecting the acceleration value of the bicycled device to thereby improve the safety of the bicycling bicycler, better satisfy the user, and improve the experience of the user.

Referring to FIG. 4B, there is another system for controlling a lamp in a bicycled device according to an embodiment of the invention, where the system includes:
A brake lamp device 41, an acceleration detecting device 42, a controller 43, and a timer 44.

Here the brake lamp device 41, and the acceleration detecting device 42 are substantially the same as in FIG. 4A.

The timer 44 is configured to receive a timing start instruction transmitted by the controller 43, and to feed a timing end message back to the controller 43 after a preset hold-on period of time elapses; and

The controller 43 is configured:
To determine a motion state of the bicycled device according to the acceleration value; and
When the motion state of the bicycled device is decelerating, and the brake lamp device 41 is switched off, to switch on the brake lamp device 41; to transmit the timing start instruction to the timer 44; and to switch off the brake lamp device 41 upon reception of the timing end message fed back by the timer 44.

Still taking the three-axis acceleration sensor as an example, a negative acceleration value on the X axis being detected indicates that the vehicle is traveling forward while decelerating, that is, the vehicle will be traveling linearly while being braked, and at this time, the distance between the vehicle and an immediately following vehicle will be decreasing; and in this case, it may be very likely for the vehicles to collide, where this collision likelihood will be higher when the negative acceleration value is larger. At this time, the brake lamp is set to be switched on; and in the embodiment of the invention, a positive acceleration value on the X axis is not considered, and the brake lamp will be controlled to be switched off directly after the preset hold-on period of time elapses after the timer is started.

Optionally the bicycled device according to the embodiment of the invention can include one of a bicycle, an electro-mobile, and a motorcycle.

In summary, in the embodiment of the invention, the acceleration value of the bicycled device is detected, and the brake lamp of the bicycled device is controlled to be switched on and off, so that the brake lamp of the bicycled device can be controlled automatically by detecting the acceleration value of the bicycled device to thereby improve the safety of the bicycling bicycler, better satisfy the user, and improve the experience of the user.

Referring to FIG. 4C, there is a further system for controlling a lamp in a bicycled device according to an embodiment of the invention, where the system includes:
A brake lamp device 41, an acceleration detecting device 42, a controller 43, a timer 44, and a power source module 45.

Here the brake lamp device 41, the acceleration detecting device 42, the controller 43, and the timer 44 are substantially the same as in FIG. 4B.

The power source module 55 is connected with the brake lamp device 41, the acceleration detecting device 42, the controller 43, and the timer 44, and configured to power the brake lamp device 41, the acceleration detecting device 42, the controller 43, and the timer 44.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the invention. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the invention; and although the invention has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the invention as claimed.

What is claimed is:

1. A method for controlling a lamp in a bicycled device, the method comprising:
detecting an acceleration value of the bicycled device; and
controlling a brake lamp of the bicycled device to be switched on and off, according to the acceleration value of the bicycled device.

2. The method according to claim 1, wherein controlling the brake lamp of the bicycled device to be switched on and off, according to the acceleration value of the bicycled device comprises:
determining a motion state of the bicycled device according to the acceleration value;
switching on the brake lamp, when the motion state of the bicycled device is decelerating, and the brake lamp is switched off;
setting a hold-on period of time; and
switching off the brake lamp after the preset hold-on period of time elapses.

3. The method according to claim 1, wherein controlling the brake lamp of the bicycled device to be switched on and off, according to the acceleration value of the bicycled device comprises:
determining a motion state of the bicycled device according to the acceleration value;
switching on the brake lamp, when the motion state of the bicycled device is decelerating, and the brake lamp is switched off; and
switching off the brake lamp, when the motion state of the bicycled device is non-decelerating, and the brake lamp is switched on.

4. The method according to claim 2, wherein determining the motion state of the bicycled device according to the acceleration value comprises:
when the acceleration value is below a acceleration threshold, determining the motion state of the bicycled device as decelerating; and
when the acceleration value is not below the acceleration threshold, determining the motion state of the bicycled device as non-decelerating.

5. A system for controlling a lamp in a bicycled device, the system comprising a brake lamp device, an acceleration detecting device, and a controller, wherein:
the acceleration detecting device is configured to detect an acceleration value of the bicycled device, and to transmit the acceleration value to the controller; and
the controller is configured to receive the acceleration value transmitted by the acceleration detecting device, and to control a brake lamp of the bicycled device to be switched on and off, according to the acceleration value.

6. The system according to claim 5, wherein the system further comprises:
a timer configured to receive a timing start instruction transmitted by the controller, and to feed a timing end message back to the controller after a preset hold-on period of time elapses; and
the controller is configured:
to determine a motion state of the bicycled device according to the acceleration value; and
when the motion state of the bicycled device is decelerating, and the brake lamp device is switched off, to switch on the brake lamp device; to transmit the timing start instruction to the timer; and to switch off the brake lamp device upon reception of the timing end message fed back by the timer.

7. The system according to claim 5, wherein the controller is configured:
to determine a motion state of the bicycled device according to the acceleration value;
to switch on the brake lamp, when the motion state of the bicycled device is decelerating, and the brake lamp is switched off; and
to switch off the brake lamp, when the motion state of the bicycled device is non-decelerating, and the brake lamp is switched on.

8. The system according to claim 6, wherein the controller is configured:
to determine the motion state of the bicycled device as decelerating when the acceleration value is below a preset acceleration threshold; and
to determine the motion state of the bicycled device as non-decelerating when the acceleration value is not below the preset acceleration threshold.

9. The system according to claim 5, wherein the bicycled device comprises
one of a bicycle, an electro-mobile, and a motorcycle.
